(19) United States
(12) Patent Application Publication
(10) Pub. No.: US 2024/0416917 A1
(43) Pub. Date: Dec. 19, 2024

(54) PREDICTIVE OVERTAKING SUPPORT

(71) Applicant: Scania CV AB, Södertälje (SE)

(72) Inventors: Alexander STAMP, Huddinge (SE); Mikael ALENIUS, Segeltorp (SE)

(73) Assignee: Scania CV AB, Södertälje (SE)

(21) Appl. No.: 18/735,841

(22) Filed: Jun. 6, 2024

(30) Foreign Application Priority Data
Jun. 14, 2023 (SE) 2350724-7

(51) Int. Cl. B60W 30/18; B60W 40/02; B60W 60/00

(52) U.S. Cl. CPC B60W 30/18163; B60W 40/02; B60W 60/001; B60W 2520/10; B60W 2554/804; B60W 2556/45

(57) ABSTRACT

The present disclosure relates to a method for providing assistance regarding a vehicle overtaking a preceding vehicle travelling ahead of the vehicle. In particular the disclosure relates to providing a recommendation regarding whether to overtake the preceding vehicle. According to a first aspect, the disclosure relates to a method for providing assistance regarding a vehicle overtaking a preceding vehicle travelling ahead of the vehicle. The method comprises obtaining information indicative of vehicle properties of the preceding vehicle that affects driving performance of the preceding vehicle in an upcoming road segment, and providing, based on the obtained information, a recommendation regarding whether to overtake the preceding vehicle. The disclosure also relates to a corresponding control arrangement and computer program, and to a vehicle comprising the control arrangement.

### TECHNICAL FIELD

The present disclosure relates to a method for providing assistance regarding a vehicle overtaking a preceding vehicle travelling ahead of the vehicle. In particular the disclosure relates to providing a recommendation regarding whether to overtake the preceding vehicle. The disclosure also relates to a corresponding control arrangement and computer program, and to a vehicle comprising the control arrangement.

### BACKGROUND

Operators of vehicles, such as commercial shipping trucks, busses, and similar large vehicles with variable weight, typically rely on their vision and line of sight to determine whether it is safe to pass a vehicle travelling ahead and merge back into the current lane. When a vehicle operator makes a miscalculation, the passing operation can take longer or be more difficult than anticipated and can result in a significant traffic backup or an unsafe driving condition as the vehicle attempts to complete the overtaking.

In particular it is hard for drivers to know when it is possible and safe to overtake another truck. At the same time it may be frustrating for a driver to be stuck behind another vehicle and then have to do overtaking on the hill. Overtaking on the hill can also be stressful for the target driver.

Methods for assisting a driver in deciding whether to overtake have been proposed. These solutions typically estimate time required to overtake based on position and acceleration capability of the vehicle. In addition it has been proposed that position, driving behavior and dimensions of the vehicle to be overtaken can be considered in order to determine whether it is safe to pass, see for example patent application US20150,344033 A1. However, such solutions may not be sufficient to provide reliable recommendations regarding heavy vehicles, such as trucks, as it is difficult to predict driving of such vehicles.

### SUMMARY

It is an objective of the present disclosure to provide methods for providing improved recommendations regarding whether to overtake a vehicle travelling ahead. In particular it is an objective to provide methods for providing recommendations that also takes into account properties of the vehicle travelling ahead. These objectives and others are at least partly achieved by the method, control arrangement, and vehicle according to the independent claims, and by the embodiments according to the dependent claims.

According to a first aspect, the disclosure relates to a method for providing assistance regarding a vehicle overtaking a preceding vehicle travelling ahead of the vehicle. The method comprises obtaining information indicative of vehicle properties of the preceding vehicle that affects driving performance of the preceding vehicle in an upcoming road segment, and providing, based on the obtained information, a recommendation regarding whether to overtake the preceding vehicle. By basing the recommendation on vehicle properties, expected individual driving performance of the preceding vehicle can be taken into account in the decision whether to take over. Consequently, the recommendation will be better (more reliable), in particular for heavy vehicles that may have poor driving performance on some types of roads (such as uphill or downhill). A reliable recommendation can make the driver more confident in overtaking decisions. As a result of good decisions, the vehicle may save driving time, increase driver satisfaction and safety. The solution may increase the rate of overtaking performing by heavy vehicles, such as trucks. This will reduce the stress of other drivers associated with having a truck stuck behind them.

In some embodiments, the recommendation is based on expected driving benefits and/or risks associated with overtaking the vehicle, wherein the driving benefits and/or risks are associated with vehicle properties of the preceding vehicle. Thereby, risks may be avoided, and benefits may be gained.

In some embodiments, the benefits comprises one or more of: a time gain associated with overtaking, and an energy gain associated with overtaking. By considering these types of benefits when making the decision, time and energy may be saved.

In some embodiments, the risks comprises one or more of: a duration of the overtaking exceeding a safety limit, that it will not be possible to overtake within a road segment having properties suitable for overtaking, and that it will not be possible to overtake within a certain distance. Some road segments are unsuitable for overtaking, e.g., because of curves, obstructed visibility or because the road is simply too narrow. If overtaking cannot be completed within a certain distance (i.e., before the road becomes unsuitable) overtaking should typically be avoided. In some scenarios overtaking may imply that the own vehicle will be forced to exceed a safety limit, such as a speed limitation or warning line, in order to complete the overtaking while avoiding other obstacles on the road, which may be illegal. Hence, overtaking may be avoided due to various risks associated with the overtaking.

In some embodiments, the driving performance is associated with acceleration capability, braking capability and/or a speed limitation of the preceding vehicle. The speed of the preceding vehicle may be limited by physical limitations or by prescribed speed limitations. By considering acceleration capability, braking capability and/or a speed limitation of the preceding vehicle it is possible to predict the speed of the preceding vehicle more accurately. This may contribute to making a better recommendation.

In some embodiments, the properties comprises one or more of vehicle dynamics, tires, vehicle mass, propulsion power, braking effect and speed limitation of the preceding vehicle. Hence, various vehicle properties that affect driving performance of the preceding vehicle may be used as a basis for the recommendation. The more properties are considered, the more accurate and/or reliable the recommendation can be.

In some embodiments, the obtaining comprises receiving the information using Vehicle-to-Everything, V2X, communication or based on sensor measurements. By using V2X up to date (real-time) information about vehicle properties may be obtained. However, the method can also be used offline based on sensor measurements.

In some embodiments, the recommendation is further based on one or more of: map data, friction data, and vehicle speed of the vehicle to overtake. Hence, the vehicle properties can be used in combination with any other relevant information. By using many different parameters as a basis for the recommendation, the more accurate and/or reliable the recommendation will be.

In some embodiments, the method comprises estimating an expected speed of the preceding vehicle in an upcoming road and providing a recommendation to overtake upon a speed of the vehicle exceeding the estimated expected speed of the preceding vehicle by a predetermined amount. Thus, the recommendation can be based on an expected difference in speed. Thereby, the risk that the vehicle will be stuck behind a slower vehicle is reduced. Also, the risk of taking over when the speed difference is too small, which may result in an unsafe situation, can be avoided.

In some embodiments, the speed is estimated based on the vehicle properties of the preceding vehicle. Vehicle properties such as propulsion power and power limitations can contribute to better speed estimations of the preceding vehicle and consequently to better recommendations.

In some embodiments, the providing comprises providing the recommendation regarding whether to overtake on a user interface or to an autonomous driving function. Hence, the method may be used both in manual and autonomous driving.

In some embodiments, the method comprises determining, based on the obtained information, expected driving benefits achieved by overtaking the vehicle.

According to a second aspect, the disclosure relates to a computer program comprising instructions which, when the computer program is executed by a computer, cause the computer to carry out the method according to the first aspect.

According to a third aspect, the disclosure relates to a computer-readable medium comprising instructions which, when executed by a computer, cause the computer to carry out the method according to the first aspect.

According to a fourth aspect, the disclosure relates to a control arrangement configured to perform the method according to the first aspect.

According to a fifth aspect, the disclosure relates to a vehicle comprising the system according to the fourth aspect.

Corresponding effects as for the first aspect can be achieved by the second to fifth aspects.

### BRIEF DESCRIPTION OF THE DRAWINGS

The embodiments disclosed herein are illustrated by way of example, and by not by way of limitation, in the figures of the accompanying drawings. Like reference numerals refer to corresponding parts throughout the drawings, in which:

FIG. 1 illustrates a vehicle where the proposed technique may be implemented.

FIG. 2a-b illustrate vehicles that are about to take over a vehicle travelling ahead.

FIG. 3 is a flow chart of an example method according to the first aspect.

FIG. 4 illustrates a control arrangement configured to perform the proposed method.

### DETAILED DESCRIPTION

The proposed technique proposes an improved method for assisting in deciding whether to overtake a vehicle travelling ahead, or not. The proposed technique is based on the insight that in order to predict how the vehicle travelling ahead (herein also called the preceding vehicle) will drive in an upcoming road segment it is beneficial to know capabilities and other properties of the preceding vehicle. For example, the preceding vehicle travelling ahead might have a weak engine or a weak auxiliary braking system and cannot travel at high speeds in downhills or uphill. In such a scenario it may be recommended to overtake, in order not to get stuck behind the preceding vehicle. If the preceding vehicle instead has a very strong engine, it may be recommended to avoid taking over, as it may be difficult to pass in a safe manner.

An overtaking decision is commonly based on prediction on whether the own vehicle will be able to overtake in a reasonable time (or distance). This expectation may be based on historic driving of the preceding vehicle and a capability of the own vehicle to accelerate past the preceding vehicle. However, the inventors have realized that an improved recommendation regarding whether to overtake, or not, can be given if vehicle properties of the vehicle travelling ahead are also considered when predicting how the vehicle travelling ahead will drive. The idea is based on the insight that vehicle properties (possibly combined with historic data) may provide a better prediction of how the preceding vehicle will drive in the upcoming road, than historic data alone. These vehicle properties may not always be visible but could be associated with properties of conditions of internal hardware.

In other words, it is herein proposed that vehicle properties of the vehicle travelling ahead are used as a basis for a recommendation regarding whether to overtake or not. In particular, it is proposed that the recommendation is based on expected driving performance (for example ability to accelerate or brake) of the vehicle travelling ahead in an upcoming road segment caused by vehicle properties. More specifically, it is proposed to use the vehicle properties as a complement to other relevant parameters commonly used today, such as map data, properties and speed of the vehicle, and speed of the preceding vehicle travelling ahead. Information about vehicle properties may for example be obtained using V2X communication and/or the vehicle properties may be determined based on object detection. By including vehicle properties of the vehicle travelling ahead as an additional parameter in the determination, benefits and risks associated with overtaking may be more accurately determined and a correct recommendation regarding overtaking can be provided.

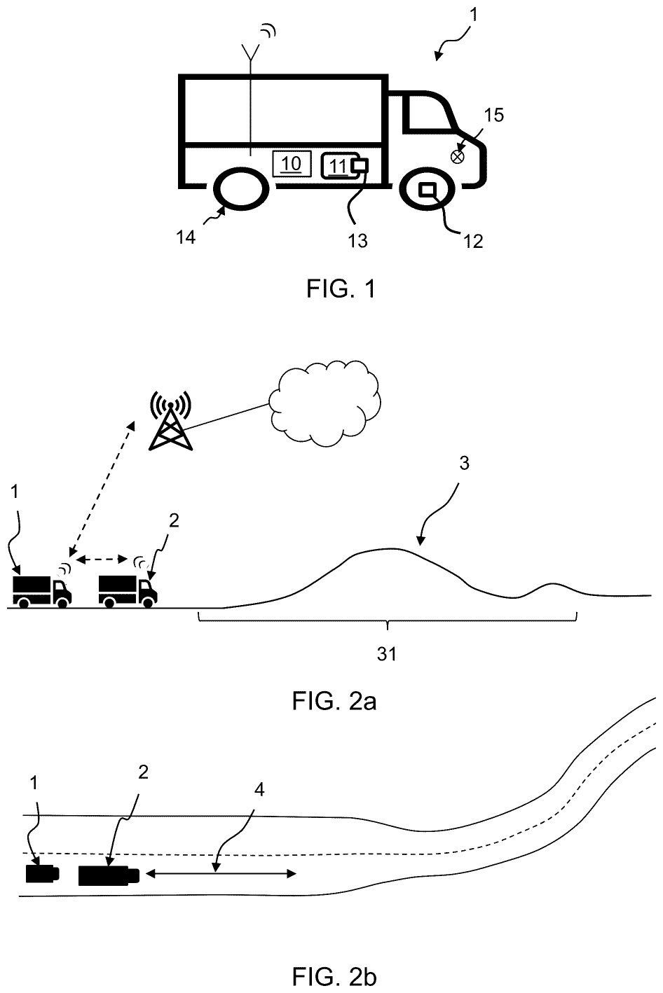

FIG. 1 illustrates a vehicle 1 where the proposed technique may be implemented. The vehicle 1 may comprise a means for transportation in broad sense and is for example a bus, a truck, or other similar manned or unmanned vehicle. The illustrated vehicle 1, here a truck, comprises a propulsion arrangement 11, primary brakes 12, secondary brakes 13, wheels/tires 14, sensors 15 and a control arrangement 10 (FIG. 4). The propulsion arrangement 11 comprises an engine and a drive train that transfers the motion to the wheels/tires 14 of the vehicle 1. The engine may include one or more of a combustion engine and an electrical engine. The primary brakes 12 are typically disc brakes or drum brakes, while the secondary brakes 13 comprises auxiliary brakes such as engine brakes or a retarder. In an electrical or hybrid vehicle the secondary brakes 13 may also or alternatively include regenerative brakes that recover braking energy and converts it into electricity.

The vehicle 1 also comprises sensors 15 used to monitor different functions and states of the vehicle 1, to provide information to the driver or to different systems of the vehicle 1. The sensors 15 may include one or more of: speed sensors, temperature sensors, position sensors, motion sensors, gyros, power sensors pressure sensors, humidity sensors etc. Each sensor 15 converts sensed events or changes of a property into a signal or data that is sent to, or collected by, the control arrangement 10. Such signals or data are, for example, sent over a CAN (Controller Area Network), or similar, of vehicle 1. The plurality of sensors 15 comprises vehicle sensors (such as LIDAR, RADAR and image sensors) for monitoring the surroundings of the vehicle 1. The output from the vehicle sensors 15 may provide input to an autonomous control system of the control arrangement 10, for use in autonomous driving.

Overtaking may be associated with various benefits and risks. Some benefits and risks may be affected by vehicle properties of the vehicle travelling ahead 2. Two example situations are illustrated in FIGS. 2a-b.

FIG. 2a illustrates a vehicle 1 that is about to take over a vehicle travelling ahead 2. In this example the upcoming road is hilly. In particular the upcoming road segment 31 comprises a steep uphill and a steep downhill. In this scenario the ability of the vehicle travelling ahead in maintaining its travelling speed may be affected by vehicle properties such as propulsion power, braking capability, or mass (e.g. due to load). Hence, vehicle properties of the vehicle travelling ahead may be of major importance when determining whether to take over or not. With the proposed technique a recommendation to take over should therefore consider vehicle properties of the vehicle travelling ahead 2. For example, an expected speed of the vehicle travelling ahead 2 may be compared with an expected speed of the own vehicle 1. By comparing expected speed curves it is possible to determine whether it is worth it to pass. More specifically, if it is expected that the own vehicle 1 will have to brake due to a lower speed of the vehicle travelling ahead 2 it would be recommended to pass. On the other hand, if it is determined that the own vehicle 1 is likely to travel at a lower speed than the vehicle travelling ahead 2 it is typically not recommended.

FIG. 2b illustrates a situation (seen from above) where overtaking is risky if it cannot be performed within a certain distance 4. After the certain distance 4 the road becomes narrow and curvy. The expected speed of the vehicle travelling ahead 2 in the upcoming road may be affected by vehicle properties such as propulsion power, braking capability, or mass (e.g. due to load), in combination with road properties (such as uphill and/or downhill). By comparing expected speed curves of the own vehicle 1 and the preceding vehicle 2 it is possible to estimate how long the passing may take. More specifically, if it is expected that the own vehicle 1 will be able to pass safely (i.e., within the certain distance 4) then it is recommended to overtake, otherwise it is not recommended.

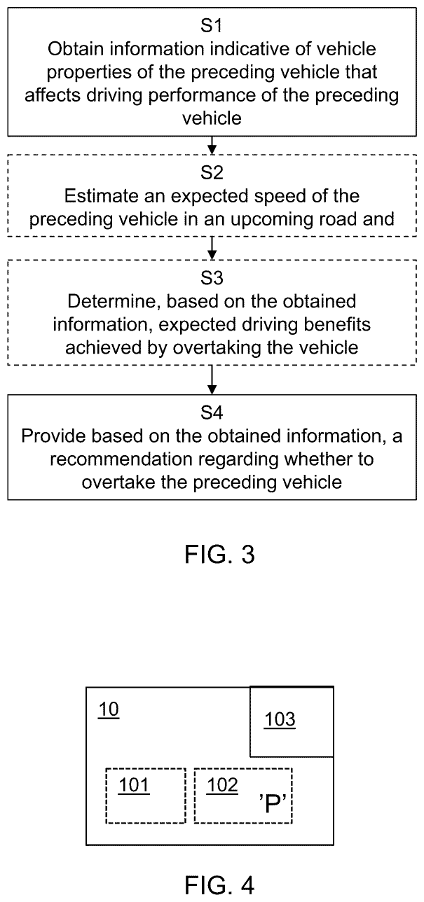

FIG. 3 illustrates the proposed method for providing assistance regarding a vehicle 1 overtaking a preceding vehicle travelling ahead 2 of the vehicle 1. The assistance herein refers to a recommendation regarding whether to overtake the preceding vehicle 2.

The method is for use in a control arrangement, such as the control arrangement 10 of the vehicle 1 (FIG. 1). The method is typically performed during normal operation of the vehicle 1 (FIG. 1), such as when an ACC is activated to control speed of the vehicle 1. Alternatively, the method may be performed to control operation of an autonomous vehicle. The method is performed during normal operation of the vehicle. The method may be repeated in an ongoing matter, such as repetitively or on demand. In other words, the method may be triggered by a request (e.g., via a user interface) from the user or based on detection of the vehicle travelling ahead 2. If a recommendation is not to take over, the method may be repeated after a certain time, or continuously, to investigate whether the recommendation has changed. The method may also be repeated for different preceding vehicles. In other words, the method steps S1-S4 may be repeated as often as feasible or required.

The method may be implemented as computer program comprising instructions which, when the program is executed by a computer (e.g., a processor in the control arrangement 10 (FIG. 4)), cause the computer to carry out the methods. According to some embodiments the computer program is stored in a computer-readable medium (e.g., a memory or a compact disc) that comprises instructions which, when executed by a computer, cause the computer to carry out the method.

The method is based on the idea of using information about the preceding vehicle 2 to gain insight about how the preceding vehicle 2 will drive in an upcoming road. For example, information vehicle properties like mass, available power and brake temperature may affect the ability of preceding vehicle 2 to accelerate and brake and is therefore relevant to consider when deciding whether to overtake (or when providing a suggestion of whether or not to overtake). Hence, the method comprises obtaining S1 information indicative of vehicle properties of the preceding vehicle 2 that affects driving performance of the preceding vehicle 2 in an upcoming road segment.

Driving performance herein refers to an ability of the preceding vehicle 2 to drive an upcoming road segment. For example, the driving performance is associated with speed. In some embodiments, the driving performance is associated with whether the preceding vehicle 2 is able to, or is expected to, maintain a certain speed in the upcoming road 3. The ability to maintain the speed may be affected by factors such as the size of the engine, charge level of battery or the capability of the brakes. The speed of the preceding vehicle 2 may also be affected by certain prescribed speed limitations relevant e.g. to a certain vehicle type, a certain road or certain vehicle/road combination. In other words, in some embodiments, the driving performance is associated with acceleration capability, braking capability and/or a speed limitation of the preceding vehicle 2. The braking capability, or deceleration capability, is a metric indicative of a braking capacity of the preceding vehicle. In other words the braking capability is a metric indicative of an ability of the preceding vehicle to slow down. In some embodiments, the braking capability indicates a maximum braking torque that brakes of the preceding vehicle 2 can generate. However, the braking capability may also be affected by other parameters such as tire properties, load, brake temperature etc. In other words, even if the brakes have a certain braking power it may not be possible to utilize it for different reasons. Hence, the braking capability may alternatively be indicated as a braking distance, or a distance required for a certain speed reduction.

The acceleration capability is a metric indicative of an acceleration capacity of the preceding vehicle 2. In other words the acceleration capability is a metric indicative of an ability of the preceding vehicle 2 to accelerate. In some embodiments, the acceleration capability indicates a maximum propulsion torque that an engine of the preceding vehicle 2 can generate.

The braking capability or acceleration capacity may also be affected by (or adjusted based on) other parameters such as mass. For example, the preceding vehicle 2 might have a weak motor or weak auxiliary braking system and cannot travel at high speeds in downhills, or uphill.

The speed limitation may also be affected by other factors such as mass (which may change e.g. depending on load). For example, a vehicle may not be allowed or capable of applying any propulsion torque above a certain speed, but it may still accelerate above the speed limitation due to gravitation. Hence, the speed limitation may be adjusted based on a current mass of the preceding vehicle 2 indicated by the vehicle properties.

The vehicle properties can be any property that is relevant to driving performance. In some embodiments, the properties comprises one or more of vehicle dynamics, tires, vehicle mass, propulsion power, braking power, brake temperature and speed limitation of the preceding vehicle. For example, the mass of the preceding vehicle 2 and the brake torque that the brakes can apply influences acceleration downhill.

The vehicle properties may be obtained using wireless communication or based on sensor measurements. Wireless data may be sent via a communication network or using a direct link between the vehicle 1 and the preceding vehicle 2. To save bandwidth simple measures such as trajectory (defining path and speed) or power-to-weight ratio (hp/ton) may be communicated.

Another option involves using sensors, such as radar to estimate how the preceding vehicle 2 drives on terrain. For example, one may estimate an acceleration ability in uphill or braking speed in downhill. Sensors may also be able to identify the vehicle or the vehicle type. Vehicle properties may then be retrieved from an on board or off-board database for the identified vehicle type. In other words, in some embodiments, the obtaining S1 comprises receiving the information using Vehicle-to-Everything, V2X, communication or based on sensor measurements.

The vehicle properties can be used to predict driving behavior of the preceding vehicle 2. For example, if the preceding vehicle 2 increases its speed in order not to be overtaken, this may mean that overtaking is not possible. In contrast, if the preceding vehicle 2 is expected to drive very slowly, then time gain associated with overtaking may be considerable. Hence, in some embodiments, the method comprises estimating S2 an expected speed of the preceding vehicle in an upcoming road. For example, the expected speed may be based on historic data and the vehicle properties. For example, if the preceding vehicle has historically driven at 90 km/h and the vehicle properties indicate that the vehicle will only be able to keep a speed of about 80 km/h in an uphill, then the expected speed is 80 km/h. The consequence may be that it is recommended to overtake.

In another example, a heavy vehicle is expected to drive at a speed of 95 km/h in a downhill, despite a historic speed of 90 km/h, due to gravitation. In this case there may be a strong recommendation not to overtake.

In a further example, the expected speed is based on a maximum speed derived based on the vehicle properties. Various vehicle properties, such as engine power, fuel level, brake temperature, weight etc, may define an upper limit of the speed.

All in all it is typically about weighing benefits towards risk. In other words, in some embodiments, the method comprises determining S3, based on the obtained information, one or more expected driving benefit achieved by overtaking the vehicle. Various benefits can be identified. For example, if the preceding vehicle 2 is expected to drive at 80 km/h and the desired speed of the vehicle 1 is 83 km/h or if the preceding vehicle 2 is expected to slow down in uphill or before a downhill, then overtaking may be associated with a time gain. In other words, in some embodiments, the benefits comprises a time gain associated with overtaking.

It may also be expected that traveling behind the preceding vehicle 2 may cause the vehicle 1 to brake, for example in downhill, whereby energy is wasted. Hence, overtaking may then be associated with a power saving. In other words, in some embodiments, the benefits comprises an energy gain associated with overtaking.

Even more important may be to be able to identify situations where overtaking is associated with safety risks. For example, one may estimate a time or distance of the overtaking and compare it to the environment. If there is a curve or similar ahead it may be very important that the vehicle 1 is able to complete overtaking before the curve. In the same way approaching road crossings, ends-of-roads, slopes, and overtaking “bans” are other properties that may constitute risks to overtaking if the required distance is too long. In other words, some embodiments, the risks comprises that it will not be possible to overtake within a certain distance. The reason for a long distance may be too little difference in expected speeds of the own vehicle 1 and the preceding vehicle 2, for example due to acceleration of braking capability as explained above.

Also, time-consuming overtaking may constitute a risk as such, and may also cause traffic queues. In other words, in some embodiments, the risks comprises that it will not be possible to overtake within a certain time.

Sometimes a speed limitation is expected to change ahead, and overtaking may not be possible without violating the speed limit. Alternatively, there may be a warning line ahead which would be crossed if an overtaking took place. In other words, in some embodiments, the risks comprises a duration of the overtaking exceeding a safety limit.

Hence, based on the obtained properties it is possible to provide assistance in the decision whether to overtake, or not. The assistance may comprise a recommendation to overtake, or a recommendation not to overtake, or a neutral recommendation, depending on the situation. For example, the message may say “you can overtake if you want” or “you must not overtake”. In other words, the method comprises providing S4, based on the obtained information, a recommendation regarding whether to overtake the preceding vehicle 2. Of course, the message may alternatively or additionally be audible or tactile, e.g., steering wheel vibration if overtaking is not recommended. A visual recommendation may also take different forms and need not be in text, but may e.g., be in the form of color coding, such as red indicating a recommendation to not overtake and green indicating a recommendation that it is safe to overtake.

The recommendation is based on a set of rules (or criteria) that may take one or more parameters as input. The rules may be preconfigured or predetermined, such as pre-programmed software in a memory 102 of a control arrangement 10 (FIG. 4). The rules may be dynamic or updated based on needs or machine learning. The rules may also result in different levels of warnings and/or recommendations. Some vehicles may only implement two levels, such as “neutral” and “do not overtake”.

For example, the set of rules may take benefits and risks as input. The rules may be configured to weight the benefits and risks associated with overtaking. For example, if there are several benefits and insignificant risks, the recommendation may still be to overtake. Significant risks should typically always result in a recommendation not to overtake. In other words, in some embodiments, the recommendation is based on expected driving benefits and/or risks associated with overtaking the vehicle, wherein the driving benefits and/or risks are associated with vehicle properties of the preceding vehicle 2.

In a particular example, the rules takes an expected speed of the preceding vehicle 2 as input. As explained above, the expected speed may be estimated based on the obtained vehicle properties. In some embodiments, the speed is estimated based on the vehicle properties of the preceding vehicle 2. The expected speed is for example compared with a desired speed of the vehicle 1, such as a speed input by a driver to a cruise controller. In some embodiments, the providing a recommendation to overtake upon a speed of the vehicle 1 exceeding the estimated expected speed of the preceding vehicle 2 by a predetermined amount.

The recommendation may also consider other facts, in addition to the driving performance derived based on the obtained vehicle properties. In some embodiments, the recommendation is further based on one or more of: map data, friction data, and vehicle speed of the vehicle to overtake. For example, the recommendation to overtake is not provided if it's not the most efficient driving strategy, even if it is safe.

In a manual vehicle, the recommendation may be displayed on the dashboard. For example, a warning may be displayed when it is not recommended to overtake. In some embodiments, the providing comprises providing the recommendation regarding whether to overtake on a user interface or to an autonomous driving function.

FIG. 4 illustrates a control arrangement 10 configured to provide assistance regarding a vehicle 1 overtaking a preceding vehicle 2 travelling ahead 2 of the vehicle 1. The control arrangement 10 may be arranged in a vehicle 1 (FIG. 1).

The control arrangement 10 comprises control circuitry to perform the method according to any one of the steps, examples or embodiments as described herein.

The control arrangement 10 may include one or more Electronic Control Units (ECUs) connected to a controller area network (CAN). For example, the control arrangement 10 may be an Electrical Control Unit, ECU, of the ACC.

More in detail, the control arrangement 10 comprises one, or more, computer(s) 101 and memory 102. The computer 101 comprises any hardware or hardware/firmware device implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner. In some embodiments, the computer-readable medium may be a non-transitory computer-readable medium, such as a tangible electronic, magnetic, optical, infrared, electromagnetic, and/or semiconductor system, apparatus, and/or device. The computer-readable memory is for example one or more of the memories in the control arrangement 10. Hence, the proposed method may be implemented as a computer program. The computer program then comprises instructions which, when the computer program is executed by a computer, cause the computer to carry out the method according to any one of the aspects, embodiments or examples as described herein.

In some embodiments the control arrangement 10 comprises a communication interface 103 configured to enable wireless communication with off-board devices, such as with other vehicles, road objects or with a data storage, such as a cloud server. The wireless communication may be performed using any suitable protocol for V2X communication. This communication may be performed via a Controller Area Network, CAN, or directly via an embedded modem.

More specifically, the control arrangement 10 is configured to obtain information indicative of vehicle properties of the preceding vehicle 2 that are affecting driving performance of the preceding vehicle 2.

In some embodiments, the control arrangement 10 is configured to estimate an expected speed of the preceding vehicle 2 in an upcoming road. In some embodiments, the control arrangement 10 is configured to determine based on the obtained information, expected driving benefits achieved by overtaking the vehicle.

The control arrangement 10 is further configured to provide, based on the obtained information, a recommendation regarding whether to overtake the preceding vehicle 1.

In further embodiments, the control arrangement is configured to perform the method according to any one of the embodiments described in connection with FIG. 3.

The terminology used in the description of the embodiments as illustrated in the accompanying drawings is not intended to be limiting of the described method, control arrangement or computer program. Various changes, substitutions and/or alterations may be made, without departing from disclosure embodiments as defined by the appended claims.

The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g. a processor may fulfil the functions of several items recited in the claims.

The present disclosure is not limited to the above-described preferred embodiments. Various alternatives, modifications and equivalents may be used. Therefore, the above embodiments should not be taken as limiting the scope of the disclosure, which is defined by the appending claims.

1. A method for providing assistance regarding a vehicle overtaking a preceding vehicle travelling ahead of the vehicle, the method comprising:
obtaining information indicative of vehicle properties of the preceding vehicle that affects driving performance of the preceding vehicle in an upcoming road segment; and
providing, based on the obtained information, a recommendation regarding whether to overtake the preceding vehicle.

2. The method according to claim 1, wherein the recommendation is based on expected driving benefits and/or risks associated with overtaking the vehicle, wherein the driving benefits and/or risks are associated with vehicle properties of the preceding vehicle.

3. The method according to claim 2 wherein the benefits and risks comprises:
benefits comprising one or more of:
a time gain associated with overtaking, and
an energy gain associated with overtaking, and
risks comprising one or more of:
a duration of the overtaking exceeding a safety limit, and
that it will not be possible to overtake within a road segment having properties suitable for overtaking, and
that it will not be possible to overtake within a certain distance.

4. The method according to claim 1, wherein the driving performance is associated with acceleration capability, braking capability, and/or a speed limitation of the preceding vehicle.

5. The method according to claim 1, wherein the properties comprise one or more of vehicle dynamics, tires, vehicle mass, propulsion power, braking effect, and speed limitation of the preceding vehicle.

6. The method according to claim 1, wherein the obtaining comprises receiving the information using vehicle-to-everything (“V2X”) communication or based on sensor measurements.

7. The method according to claim 1, wherein the recommendation is further based on one or more of: map data, friction data, and vehicle speed of the vehicle to overtake.

8. The method according to claim 1, wherein the method comprises:
estimating an expected speed of the preceding vehicle in an upcoming road; and
providing a recommendation to overtake upon a speed of the vehicle exceeding the estimated expected speed of the preceding vehicle by a predetermined amount.

9. The method according to claim 1, wherein the speed is estimated based on the vehicle properties of the preceding vehicle.

10. The method according to claim 1, wherein the providing comprises providing the recommendation regarding whether to overtake on a user interface or to an autonomous driving function.

11. A computer program product stored on a non-transitory computer-readable medium, said computer program product for providing assistance regarding a vehicle overtaking a preceding vehicle travelling ahead of the vehicle, wherein said computer program product comprising computer instructions to cause one or more computer processors to perform the following operations:
obtaining information indicative of vehicle properties of the preceding vehicle that affects driving performance of the preceding vehicle in an upcoming road segment; and
providing, based on the obtained information, a recommendation regarding whether to overtake the preceding vehicle.

12. (canceled)

13. A control arrangement configured to operate a vehicle comprising secondary brakes, wherein the control arrangement is configured to:
obtain information indicative of vehicle properties of the preceding vehicle that are affecting driving performance of the preceding vehicle; and
provide, based on the obtained information, a recommendation regarding whether to overtake the preceding vehicle.

14. (canceled)

15. A vehicle comprising a control arrangement configured to operate a vehicle comprising secondary brakes. wherein the control arrangement is configured to:
obtain information indicative of vehicle properties of the preceding vehicle that are affecting driving performance of the preceding vehicle; and
provide, based on the obtained information, a recommendation regarding whether to overtake the preceding vehicle.

16. The control arrangement according to claim 13, wherein the recommendation is based on expected driving benefits and/or risks associated with overtaking the vehicle, wherein the driving benefits and/or risks are associated with vehicle properties of the preceding vehicle.

17. The control arrangement according to claim 16, wherein the benefits and risks comprises:
benefits comprising one or more of:
a time gain associated with overtaking, and
an energy gain associated with overtaking, and
risks comprising one or more of:
a duration of the overtaking exceeding a safety limit, and
that it will not be possible to overtake within a road segment having properties suitable for overtaking, and
that it will not be possible to overtake within a certain distance.

18. The control arrangement according to claim 13, wherein the driving performance is associated with acceleration capability, braking capability, and/or a speed limitation of the preceding vehicle.

19. The control arrangement according to claim 13, wherein the properties comprise one or more of vehicle dynamics, tires, vehicle mass, propulsion power, braking effect, and speed limitation of the preceding vehicle.

20. The control arrangement according to claim 13, wherein the obtaining comprises receiving the information using vehicle-to-everything (“V2X”) communication or based on sensor measurements.

21. The control arrangement according to claim 13, wherein the recommendation is further based on one or more of: map data, friction data, and vehicle speed of the vehicle to overtake.

22. The control arrangement according to claim 13 further configured to:
estimating an expected speed of the preceding vehicle in an upcoming road; and
providing a recommendation to overtake upon a speed of the vehicle exceeding the estimated expected speed of the preceding vehicle by a predetermined amount.
